(19) United States
(12) Patent Application Publication
(10) Pub. No.: US 2014/0073233 A1
(43) Pub. Date: Mar. 13, 2014

(54) VENT FLAP ARRANGEMENT HAVING AN ECCENTRIC FLAP MOUNTING

(71) Applicant: Roechling Automotive AG & Co. KG, Mannheim (DE)

(72) Inventor: Andreas SCHMITT, Abenheim (DE)

(73) Assignee: Roechling Automotive AG & Co. KG, Mannheim (DE)

(21) Appl. No.: 14/019,720

(22) Filed: Sep. 6, 2013

(30) Foreign Application Priority Data
Sep. 7, 2012 (DE) 10 2012 215 942.8

(51) Int. Cl. B60K 11/08

(52) U.S. Cl. CPC B60K 11/085
USPC 454/143

(57) ABSTRACT

Vent flap arrangement for a motor vehicle including a support structure with an air passage opening, at least one vent flap provided on the support structure such that it can pivot about a flap axis. The flap axis is arranged relative to the vent flap such that the product of the area of a first vent flap surface located between the first flap longitudinal edge and the flap axis on the upstream side of the vent flap and the distance of a centre of gravity of the first flap surface is approximately 1.4 to 4.2 times as great as the product of the area of a second flap surface located between the second flap longitudinal edge and the flap axis on the upstream side of the vent flap and the distance of a centre of gravity of the second vent flap surface.

The present invention relates to a vent flap arrangement for a motor vehicle, comprising a support structure with an air passage opening, at least one vent flap (which may also be referred to as “air flap”) which is provided on the support structure such that it can pivot about a flap axis between a closed position and an open position to adjust a flow cross section of the air passage opening, the flow cross section being minimal in the closed position, and the flap axis running between a first flap longitudinal edge of the vent flap and a second flap longitudinal edge of the vent flap such that when the vent flap pivots from a position which is closer to the closed position to a position which is closer to the open position, the first flap longitudinal edge is pivoted downstream relative to a flow direction of air flowing onto the vent flap arrangement during operation and the second flap longitudinal edge is pivoted upstream. The vent flap arrangement also comprises a faceplate arrangement (which may also be termed “aperture arrangement”) having two faceplate longitudinal edges between which the flap axis runs, one faceplate longitudinal edge being associated with each longitudinal flap edge such that in the closed position of the vent flap, the distance of the flap longitudinal edge to the associated faceplate longitudinal edge is shorter than to any other faceplate longitudinal edge, and such that a distance between the flap longitudinal edge and the associated faceplate longitudinal edge is shorter in the closed position than in the open position.

Vent flap arrangements of this type having one or more pivotable vent flaps are sufficiently well known in the field of automotive engineering. In many motor vehicles, vent flap arrangements having pivotable vent flaps, for example, are used in the front region of the vehicle and, depending on the position of said vent flaps, a variable proportion of the air flowing onto the front of the vehicle during driving is conveyed as cooling air to the engine compartment. If cooling of the engine is not strictly necessary, the front flaps can be closed, which reduces the air resistance of the vehicle and thereby reduces the fuel consumption thereof.

The known vent flap arrangements are of a symmetrical construction; for conventional vent flaps which have a rectangular basic shape, the flap axis is therefore arranged approximately in the centre of the total flap surface.

In order to still be able to function reliably at high speeds as well, actuators are required to drive the adjustment movements of the vent flaps, which actuators can output relatively great torques. Actuators of this type are expensive and also require a relatively large installation space. Furthermore, the energy consumption by the actuators is correspondingly high.

In view of this prior art, the object of the present invention is therefore to develop the known vent flap arrangement such that a reliable operation is possible at high velocities also with an actuator, which can provide only a relatively lower maximum torque.

To achieve this object, the invention proposes that with a known vent flap arrangement, the flap axis is arranged relative to the vent flap such that the product of the area of a first flap surface located on the upstream side of the vent flap between the first flap longitudinal edge and the flap axis and the distance of a centre of gravity of the first flap surface from the flap axis is approximately 1.4 to 4.2 times as great as the product of the area of a second flap surface located on the upstream side of the vent flap between the second flap longitudinal edge and the flap axis and the distance of a centre of gravity of the second flap surface from the flap axis.

Flow simulation calculations carried out by the applicant have shown that torques which act on the vent flaps during operation can become high, not necessarily only during closure of the vent flaps, but also during the opening thereof. Thus, when there are small aperture angles, due to the air which flows onto and around the vent flaps during driving, regions of reduced pressure are produced on the flap longitudinal edges, which regions result in a resulting torque in the closed direction (towards the closed position).

According to the invention, this torque in the closed direction is reduced or compensated by a torque in the open direction (towards the open position or from a position closer to the closed position to a position closer to the open position) which is produced by a suitable asymmetry of the vent flap.

The torque acting on a blade of the flap against which air flows is produced in the first approximation as the product of flow pressure, area of the air-impacted flap blade and lever arm, i.e. distance of the centroid of the impacted surface of the flap blade in question to the flap axis.

The ratio of the torques acting on the two flap blades defined by the flap axis is consequently given as the ratio of the products of area and lever arm. Taken into the approximation is the fact that the flow pressure along the entire vent flap is substantially constant, air flows substantially vertically against the vent flap and material thickness and density along the vent flap are likewise approximately constant.

A further advantageous effect of the vent flap arrangement according to the invention is that when vent flaps are wide open or fully open, i.e. particularly when they are in the open position, the position of the individual vent flaps is significantly more stable even with a strong on-flow of air than in the case of known, symmetrically mounted vent flaps; thus a self-stabilisation is produced.

Even if air does not flow against the vent flap in question in an exactly perpendicular manner, “area” can mean here the actual area of the respective (first or second) flap surface, not necessarily the projection thereof in the direction of flow, which affords the advantage that the actual area can be determined irrespective of knowing the exact flow conditions. The same applies accordingly to the (centroid) centre of gravity of the first or second flap surface.

However, for flow-dynamic reasons, it is preferred to understand the expressions “area” and/or “centroid” of the first and second flap surface as meaning the area and/or centroid of the first and second flap surface which is projected in the direction of flow where, in case of doubt, “direction of flow” is to be understood as a direction orthogonal to a plane defined by the air passage opening of the support structure.

It should be noted here that regions, covered in the closed position, of the upstream side of the vent flap are also included among the first and second flap surfaces within the meaning of this invention, since the flow-around effect, described above, which results in a torque in the closed direction when there are small aperture angles, occurs in a state in which the vent flap is slightly open and thus air flows around the entire flap surface, i.e. also around regions which are covered in the closed position.

Furthermore, the first and second flap surface, apart from exceptions mentioned in the following, is understood as meaning the entire flap surface located between flap axis and respective flap longitudinal edge, and not, for example, only parts thereof.

However, it can be provided (for example in the case of flaps with projecting reinforcing ribs on the air-impacted side of the flap), that during the calculation of the area and/or centre of gravity, only those area portions are considered for which the component of the normal vector perpendicular to the flap axis is greater than the component of the normal vector parallel to the flap axis. Preferably only those area portions are considered for which the component of the normal vector perpendicular to the flap axis is more than double the magnitude, more preferably is more than ten times the magnitude of the component parallel to the flap axis, i.e. those area portions which extend substantially parallel to the flap axis, because area portions which extend perpendicularly to the flap axis are less significant in the calculation of the torque acting on the entire flap during onflow and around-flow.

In the simulation calculations by the applicant, starting from a given, known vent flap arrangement of a symmetrical construction as described above, the axial mounting point was moved several times, and the torques acting on the individual vent flaps were calculated for different axial mounting points when there are small aperture angles and predetermined velocities of the onflowing air. Here, the vent flaps can be considered in a section perpendicular to the flap axes, the total torque acting on the respective vent flap being produced when considering all moments acting along the entire contour of the vent flap in the section in question due to the onflow and around-flow.

The result of these simulation calculations is that the torques acting on the vent flaps, when there are small aperture angles (for example 10° to 15°), in the configuration according to the invention are considerably reduced compared to the known symmetrical vent flap arrangement.

Due to the lower torque which acts on the vent flap, it is possible to use actuators with a smaller output moment which consume less energy and in particular require less installation space, so that the vent flap arrangement can be accommodated in a relatively small space inside the motor vehicle. Alternatively, more reliable operation up to higher velocities can be ensured with a given actuator than in the case of a generic vent flap arrangement.

In the case of commonly used vent flaps having a substantially rectangular basic shape, the desired torque ratio is satisfied when a dimension of the second flap surface perpendicular to the flap axis (blade length of the second flap blade) is approximately 0.33 to 0.45 times as great as a dimension of the total flap surface perpendicular to the flap axis (total blade length), in other words, if the flap axis does not run in the centre of a total flap surface, but in a region between approximately 33% and 45% of the total blade length perpendicular to the flap axis. Thus, in the case of a vent flap having a rectangular basic shape, the first flap surface can make up approximately 55% to 67% of the total vent flap surface and accordingly, the second flap surface can make up approximately 45% to 33%.

In the closed position, it is usually desirable for as little air as possible to flow into the inner region of the motor vehicle through the vent flap arrangement. This can be easily ensured in that in the closed position, at least one peripheral portion of the vent flap, including a flap longitudinal edge of the vent flap, overlaps a peripheral portion of the faceplate arrangement which includes the faceplate longitudinal edge associated with the flap longitudinal edge.

The sealing of the vent flap arrangement in the closed position of the vent flap can be further improved in that in the closed position, for both flap longitudinal edges, at least one peripheral portion of the vent flap, including the respective flap longitudinal edge, overlaps a peripheral portion of the faceplate arrangement which includes the faceplate longitudinal edge associated with the respective flap longitudinal edge.

To increase the stability of the vent flap arrangement, it can be provided that the faceplate arrangement or at least part thereof is stationary relative to the support structure. In particular, in this case the faceplate arrangement can be part of the support structure.

However, with regard to the reduction of material and thereby to saving weight, it can be provided in addition or as an alternative that the vent flap arrangement comprises at least one other vent flap which is arranged on the support structure such that it can pivot about a flap axis and which is positioned such that the axis thereof runs parallel to the axis of the one flap, and that a flap longitudinal edge vent flap forms the longitudinal edge of the faceplate arrangement, which faceplate longitudinal edge is associated with one of the flap longitudinal edges of the one vent flap.

Here, but also in the event that the faceplate arrangement is formed at least in part by the support structure, it can be provided that the vent flap arrangement comprises a plurality of similar vent flaps which are pivotably provided on the support structure, the axes of which flaps run parallel to one another and which flaps are arranged in a row perpendicular to the direction of the flap axes.

A plurality of parallel vent flaps allows a large flow cross section in the open position of the vent flaps, without letting the adjustment movements, required for opening and closing, become too great. Furthermore, in a particularly simple manner, parallel vent flaps can be jointly controlled or coupled for joint movement.

In the following, the present invention will be discussed with reference to a preferred embodiment which is illustrated in the accompanying figures.

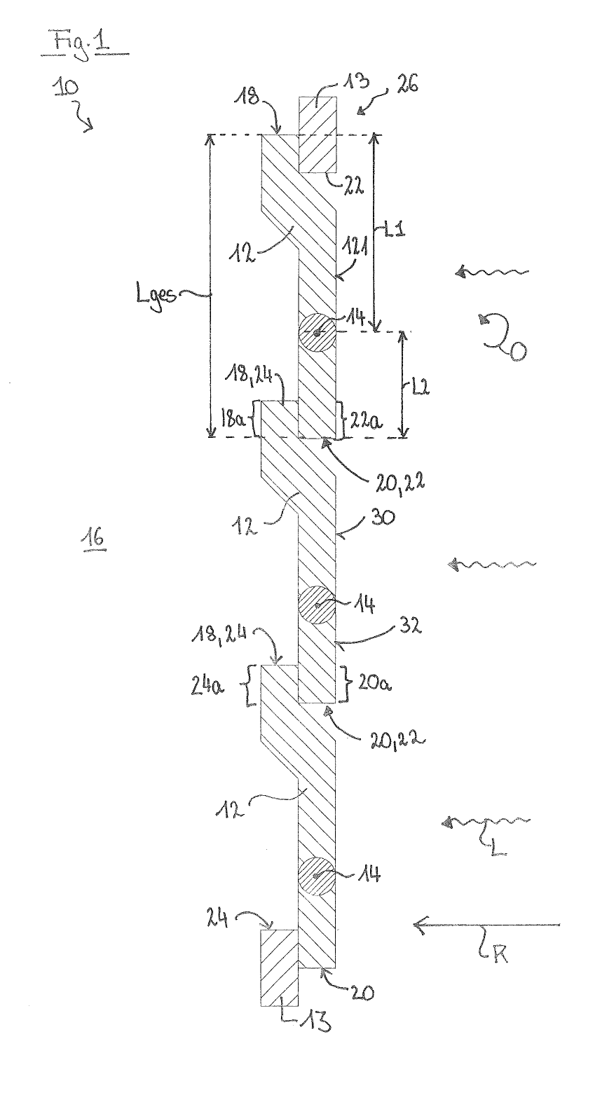

FIG. 1 is a sectional view of a vent flap arrangement according to a first embodiment of the invention,

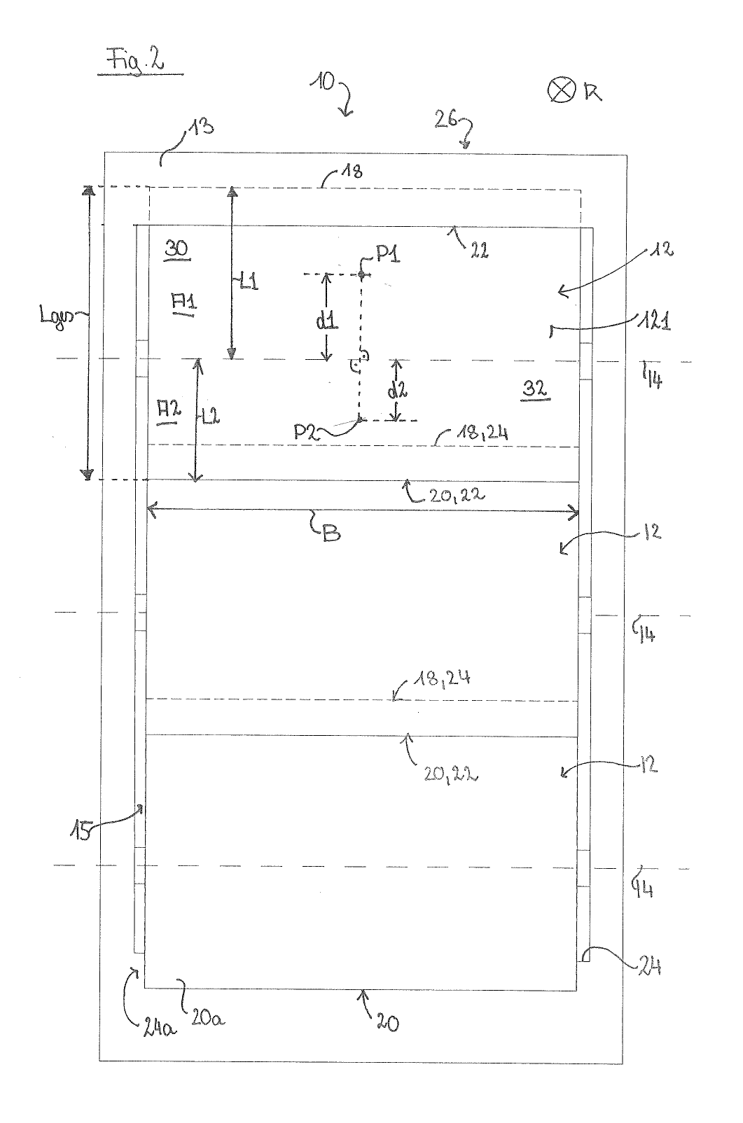

FIG. 2 is a plan view of the subject of FIG. 1,

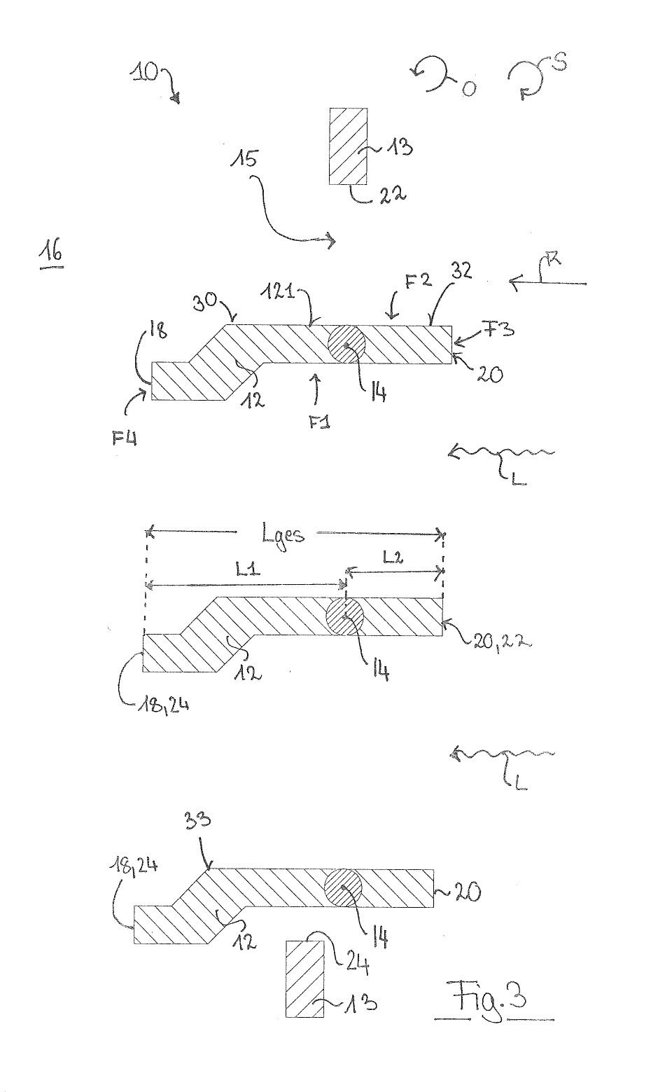

FIG. 3 shows the subject of FIG. 1, the vent flaps being in the open position here, and

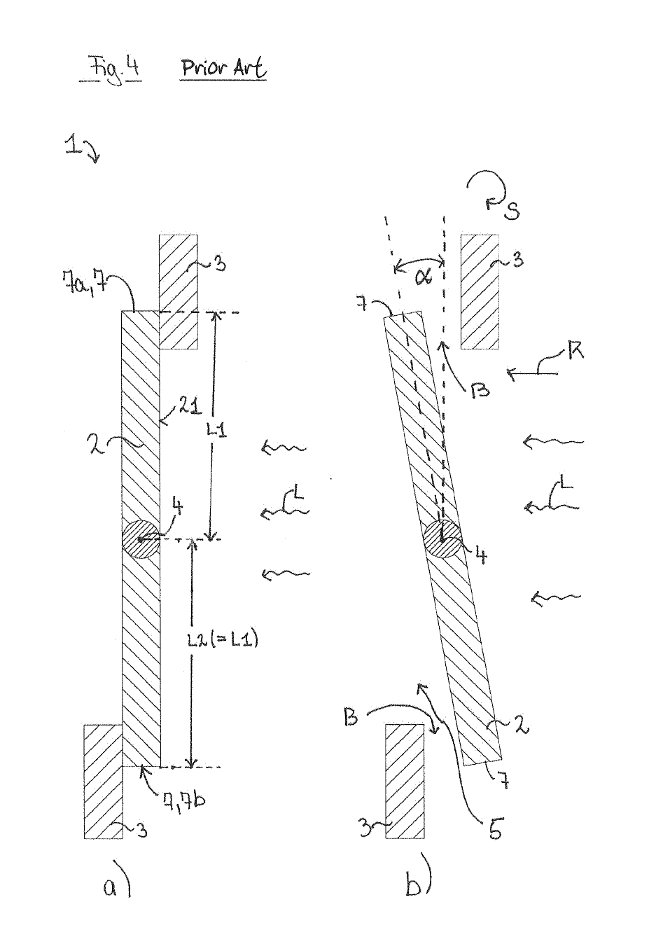

FIG. 4 shows a comparative example, known from the prior art, of a generic vent flap arrangement in partial views a) and b).

All the figures are greatly simplified schematic drawings which in particular are not to be understood as being true-to-scale. So as not to overload the figures, not all the illustrated components are always provided with reference signs for all the features.

As mentioned above, simulation calculations by the applicant have shown that in the case of known symmetrical vent flap arrangements, such as the vent flap arrangement 1 shown in FIG. 4, in which a vent flap 2 is provided on a support structure 3 such that it can pivot about a flap axis 4, to vary a flow cross section of an air passage opening 5 provided in the support structure 3, regions B of a reduced pressure (cf. partial view b)) develop in the region of the flap longitudinal edges 7 for small aperture angles a of the vent flap 2 (for example 10° or 15°) due to the air L flowing onto the vent flap arrangement 1 during operation, which regions can produce considerable torques in the closed direction S (i.e. towards the closed position shown in partial view a)). In the case of the vent flap 2 shown here having a rectangular basic shape, a symmetrical arrangement means that a dimension L1 of a flap surface, perpendicular to the flap axis 4, located between a flap longitudinal edge 7a and the flap axis 4 on the upstream side 21 of the vent flap 2, is approximately exactly the same size as the dimension L2 of a second flap surface, perpendicular to the flap axis 4, located between the other flap longitudinal edge 7b and the flap axis 4.

As explained in the following, the aforementioned flow-induced torques in the closed direction S for small aperture angles are compensated or are at least reduced by a suitable eccentric mounting of the flap axis in the vent flap arrangements according to the invention.

The vent flap arrangement 10 of the invention according to the first embodiment of the invention illustrated in FIG. 1 comprises at least one vent flap 12 (in the present case, by way of example three vent flaps) which is provided on a support structure 13 which is merely indicated in the figure, such that it can pivot about an associated flap axis 14, said vent flap 12 being able to pivot between the closed position shown in FIG. 1 and the open position shown in FIG. 3 to vary the flow cross section of an air passage opening 15 provided in the support structure 13 (cf. FIG. 3).

As a result, it is possible to vary the amount of air L which flows onto the vent flap arrangement during operation and is fed to the inner region 16 of a motor vehicle through the vent flap arrangement 10.

The flap axis 14 is arranged between a first flap longitudinal edge 18 and a second flap longitudinal edge 20 of the vent flap 12 such that during a pivoting movement of the vent flap 12 in an open direction 0, i.e. during a pivoting movement of the vent flap 12 from the closed position or from a position closer to the closed position to the open position or to a position closer to the open position, the first flap longitudinal edge 18 is pivoted downstream relative to a flow direction R of air L flowing onto the vent flap arrangement during operation and the second flap longitudinal edge 20 is pivoted upstream.

Associated with each of the flap longitudinal edges 18 and 20 is a faceplate longitudinal edge 22 and 24, respectively, of a faceplate arrangement 26 such that in the closed position of the vent flap 12 (FIG. 1), the distance of the respective flap longitudinal edge 18, 20 from the associated faceplate longitudinal edge 22, 24 is shorter than from any other faceplate longitudinal edge 24, 22, and such that a distance between the flap longitudinal edge 18, 20 and the associated faceplate longitudinal edge 22, 24 in the closed position is shorter than in the open position. In the present example, the aforementioned distance in the closed position is zero in the first approximation.

In contrast to the known vent flap arrangements, as shown for example in FIG. 4, in the vent flap arrangement 10 according to the invention in FIG. 1, the mounting of the flap axis 14 is eccentric.

Since the first and second flap surfaces 30, 32 each have an approximately rectangular shape with a constant width B (identical for both flap surfaces) (cf. FIG. 2), the following relation is produced in the present case for the ratio of the torques acting on the two flap surfaces due to a uniform vertical onflow, in the first approximation (without considering the onflow and around-flow effects, illustrated in FIG. 4, and while disregarding the fact that air does not flow onto the covered regions in the closed position):

|M1:M2|=(A1·d1):(A2·d2)=(B·L1·½·L2):(B·L2·½·L2)=(L1:L2)²

According to the invention, the product (A1·d1= 1/2·B·L1²) of the area A1 of a first flap surface 30 located between the first flap longitudinal edge 18 and the flap axis 14 on the upstream side 121 of the vent flap 12 and the distance d1 of a centre of gravity P1 of the first flap surface 30 from the flap axis 14 is approximately 1.4 to 4.2 times as great as the product (A2·d2=½·B·L2²) of the area A2 of a second flap surface 32 located between the second flap longitudinal edge 20 and the flap axis 14 on the upstream side 121 of the vent flap 12 and the distance d2 of a centre of gravity P2 of the second vent flap surface 32 from the flap axis 14.

Consequently, in the case of the illustrated flap axes having a rectangular basic shape, the flap axis 14 is arranged in the region between approximately 33% and 45% of the total blade length Lges=L1+L2, perpendicular to the flap axis 14 so that the first flap surface 30 is slightly greater than the second flap surface 32. Expressed more precisely:

M1:M2=(L1:L2)²≈1.4 to 4.2

→L1:L2≈1.2 to 2.05

→L1:(L1+L2)≈0.67 to 0.55

→L2:(L1+L2)≈0.33 to 0.45

The asymmetry described above facilitates an opening movement of the vent flap 14 during the onflow of air and thereby counteracts the torque towards the closed position which arises due to the onflow and around-flow during driving in the case of small aperture angles, the simulation calculations by the applicant showing that the arrangement according to the invention of the flap axis can particularly effectively counteract the torque in the closed direction.

In these simulation calculations, in each case for a given geometry, position and arrangement of the vent flaps, viewed in a sectional plane perpendicular to the flap axis, for different axial mounting points (and therefore for different ratios of L1/L2), the total torque on each vent flap was calculated from the moments acting on all four surfaces F1 to F4 (cf. FIG. 3) of the respective flap, and it was investigated for which axial mounting the resulting total torque is smallest, resulting in the vent flap arrangement according to the invention when considering numerous different geometries, positions etc.

Furthermore, it has been found in practice that the position of the vent flaps 12 of the vent flap arrangement 10 according to the invention in the open position shown in FIG. 3 is significantly more stable even with a strong onflow of air than in the case of the known vent flap arrangements having a symmetrical axial mounting, which often begin to judder when there is a strong onflow of air in an open position corresponding to FIG. 3.

In the present embodiment, the faceplate longitudinal edge 22 associated with the first flap longitudinal edge 18 of the top vent flap 12 and the faceplate longitudinal edge 24 associated with the second flap longitudinal edge 20 of the bottom vent flap 12 are formed in each case by parts of the support structure 13, while the faceplate longitudinal edge 22 associated with the first flap longitudinal edge 18 of the middle vent flap 12 is formed by the second flap longitudinal edge 20 of the top vent flap 12 and the faceplate longitudinal edge 24 associated with the second flap longitudinal edge 20 of the middle vent flap is formed by the first flap longitudinal edge 18 of the bottom vent flap 12 (cf. FIGS. 1 and 2).

Furthermore, in the illustrated embodiment, the flap longitudinal edges 18, 20 can overlap with the respectively associated faceplate longitudinal edges 22, 24. More precisely, it can be provided that for each of the flap longitudinal edges 18, 20, a peripheral portion 18a, 20a of the vent flap 12, including the respective flap longitudinal edge 18, 20 overlaps a peripheral portion 22a, 24a of the faceplate arrangement, which peripheral portion 22a, 24a includes the faceplate longitudinal edge 22, 24 associated with the flap longitudinal edge 18, 20. For reasons of clarity, the peripheral portions 18a, 20a, 22a and 24a in FIG. 1 have only been shown for the middle vent flap 12.

The optimum axial mounting point for a given vent flap configuration can be determined by numerical flow simulation calculations, for example using suitable software, such as ANSYS ICEM CFD and ANSYS CFX. In this software, the flow conditions are considered on a two-dimensional section of a vent flap arrangement in a sectional plane perpendicular to the flap axis which corresponds to the sectional planes of FIGS. 1 and 3.

Starting from a symmetrical axial mounting (as in FIG. 4), flow conditions are calculated for a predetermined flow velocity of the onflowing air and for a predetermined aperture angle and the torques which respectively act on the individual vent flaps are calculated therefrom, and thereafter the axial bearing point is moved and the calculation is repeated under otherwise identical constraints, so that as a result of a plurality of such calculations, the optimum axial bearing point can be determined as the point at which the torques arising on the vent flaps are minimal or are at least small enough to guarantee a reliable operation of the vent flap arrangement with predetermined actuators up to a desired maximum flow velocity.

Wind tunnel tests using an appropriate prototype have shown that with the vent flap arrangement according to the invention, compared to a known, symmetrical vent flap arrangement using the same actuators and otherwise applying the same constraints, it is possible to achieve a reliable operation of the vent flap arrangement at up to 20 km/h higher velocities of the onflowing air (and thereby driving speeds of the motor vehicle), and in the present case at velocities of up to 210 km/h. Furthermore, the position of the vent flaps of the vent flap arrangement according to the invention in the open position is significantly more stable even with a strong onflow of air than in the case of the known, symmetrical vent flap arrangements.

1. Vent flap arrangement (10) for a motor vehicle, comprising:
a support structure (13) with an air passage opening (15),
at least one vent flap (12) which is provided on the support structure (13) such that it can pivot about a flap axis (14) between a closed position and an open position to adjust a flow cross section of the air passage opening (15), the flow cross section being minimal in the closed position and the flap axis (14) running between a first flap longitudinal edge (18) and a second flap longitudinal edge (20) of the vent flap (12) such that when the vent flap (12) pivots from a position closer to the closed position to a position closer to the open position, the first flap longitudinal edge (18) is pivoted downstream relative to a flow direction (R) by air (L) flowing onto the vent flap arrangement (10) during operation, and the second flap longitudinal edge (20) is pivoted upstream,
a faceplate arrangement (26) having two faceplate longitudinal edges (22, 24), between which the flap axis (14) runs, wherein associated with each flap longitudinal edge (18, 20) is a faceplate longitudinal edge (22, 24) such that in the closed position of the vent flap (12), the distance of the flap longitudinal edge (18, 20) from the associated faceplate longitudinal edge (22, 24) is shorter than from any other faceplate longitudinal edge (24, 22), and such that a distance between the flap longitudinal edge (18, 20) and the associated faceplate longitudinal edge (22, 24) is shorter in the closed position than in the open position,
characterised in that the flap axis (14) is arranged relative to the vent flap (12) such that the product (A1·d1) of the area (A1) of a first vent flap surface (30) located between the first flap longitudinal edge (18) and the flap axis (14) on the upstream side (121) of the vent flap (12) and the distance (d1) of a centre of gravity (P1) of the first flap surface (30) from the flap axis (14) is approximately 1.4 to 4.2 times as great as the product (A2·d2) of the area (A2) of a second flap surface (32) located between the second flap longitudinal edge (20) and the flap axis (14) on the upstream side (121) of the vent flap (12) and the distance (d2) of a centre of gravity (P2) of the second flap surface (32) from the flap axis (14).

2. Vent flap arrangement (10) according to claim 1, characterised in that a dimension (L2) of the second flap surface (30) perpendicular to the flap axis (14) is approximately 0.33 to 0.45 times as great as a dimension (Lges=L1+L2) of the total flap surface (32) on the upstream side (121) of the vent flap between the first flap longitudinal edge (18) and the second flap longitudinal edge (20) perpendicularly to the flap axis (14).

3. Vent flap arrangement (10) according to claim 1, characterised in that in the closed position, at least one peripheral portion (18a, 20a) of the vent flap (12) which includes a flap longitudinal edge (18, 20) of the vent flap (12) overlaps a peripheral portion (22a, 24a) of the faceplate arrangement (26), which peripheral portion includes the faceplate longitudinal edge (22, 24) associated with the flap longitudinal edge (18, 20).

4. Vent flap arrangement (10) according to claim 1, characterised in that for both flap longitudinal edges (18, 20) in the closed position, at least one peripheral portion (18a, 20a) of the vent flap (12) which includes the respective flap longitudinal edge (18, 20) of the vent flap (12) overlaps a peripheral portion (22a, 24a) of the faceplate arrangement (26), which peripheral portion includes the faceplate longitudinal edge (22, 24) associated with the respective flap longitudinal edge (18, 20).

5. Vent flap arrangement (10) according to claim 1, characterised in that the faceplate arrangement (26) or at least a part thereof is provided to be stationary relative to the support structure (13).

6. Vent flap arrangement (10) according to claim 1, characterised in that it comprises at least one other vent flap (12) which is arranged on the support structure (13) such that it can pivot about a flap axis (14) and which is positioned such that the flap axis (14) thereof runs parallel with the flap axis (14) of the one vent flap (12), and in that a flap longitudinal edge (20, 18) of the other vent flap (12) forms the faceplate longitudinal edge (22, 24) of the faceplate arrangement (26), which faceplate longitudinal edge is associated with one of the flap longitudinal edges (18, 20) of the one vent flap (12).

7. Vent flap arrangement (10) according to claim 1, in particular according to claim 6, characterised in that it comprises a plurality of similar vent flaps (12) which are pivotably provided on the support structure (13), the flap axes (14) of which run parallel to one another and which vent flaps are arranged in a row perpendicular to the direction of the vent flaps axes (14).
